(19) United States
(12) Patent Application Publication
(10) Pub. No.: US 2026/0241558 A1
(43) Pub. Date: Aug. 20, 2026

(54) INFORMATION PROCESSING DEVICE, INFORMATION PROCESSING METHOD, AND RECORDING MEDIUM

(71) Applicant: NEC Corporation, Tokyo (JP)

(72) Inventor: Manao MACHIDA, Tokyo (JP)

(73) Assignee: NEC Corporation, Tokyo (JP)

(21) Appl. No.: 19/158,959

(22) PCT Filed: Feb. 28, 2023
(86) PCT No.: PCT/JP2023/007308

§ 371 Date: Aug. 22, 2025

(51) Int. Cl. B25J 9/16

(52) U.S. Cl. CPC B25J 9/1664; B25J 9/1605; G05B 2219/39001

(57) ABSTRACT

The information processing device for an action of a robot includes: an automaton generation unit that generates an automaton, which is a model indicating state transitions in a task to be executed; an automaton-based planning unit that generates an action plan based on the automaton; and a transition system-based planning unit that generates a robot action plan for executing the action plan based on the automaton, on the basis of a transition system, which is a model indicating state transitions due to robot actions.

### TECHNICAL FIELD

The present invention relates to an information processing device, an information processing method, and a recording medium.

### BACKGROUND ART

Action plans for a plurality of cooperating robots may be generated.

For example, in the multi-agent system described in PTL 1, each robot obtains a plurality of options defining a plurality of actions for achieving transition from a current system state to a subsequent system state. Then, each robot obtains an action cost for executing the action indicated by the option for each of the plurality of options. The action cost value obtained for each option is considered by each remaining robot, and each robot performs an action relevant to one of the plurality of options.

### CITATION LIST

### Patent Literature

PTL 1: JP 2019-200792 A

### SUMMARY OF INVENTION

### Technical Problem

When generating an action plan for achieving a task using a plurality of robots, the time required for generating the action plan may be short even when the number of robots is large.

An object of the present invention is to provide an information processing device, an information processing method, and a recording medium capable of solving the above-described problems.

### Solution to Problem

According to a first aspect of the present invention, an information processing device includes: an automaton generation means for generating an automaton which is a model indicating a state transition in a task to be executed; an automaton-based planning means for generating an action plan based on the automaton; and a transition system-based planning means for generating an action plan of a robot for executing the action plan based on the automaton, based on a transition system which is a model indicating a state transition due to an action of a robot.

According to a second aspect of the present invention, an information processing method causes a computer to execute: generating an automaton which is a model indicating a state transition in a task to be executed; generating an action plan based on the automaton; and generating an action plan of a robot for executing the action plan based on the automaton, based on a transition system which is a model indicating a state transition due to an action of a robot.

According to a third aspect of the present invention, a recording medium has stored therein a program for causing a computer to execute: a process of generating an automaton which is a model indicating a state transition in a task to be executed; a process of generating an action plan based on the automaton; and a process of generating an action plan of a robot for executing the action plan based on the automaton, based on a transition system which is a model indicating a state transition due to an action of a robot.

### Advantageous Effects of Invention

According to the present invention, when an action plan for achieving a task using a plurality of robots is generated, it is expected that the time required for generating the action plan is relatively short even when the number of robots is relatively large.

### BRIEF DESCRIPTION OF DRAWINGS

FIG. 1 is a diagram illustrating an example of a configuration of an information processing device according to a first example embodiment.

FIG. 2 is a diagram illustrating an example of a procedure of processing performed by the information processing device according to the first example embodiment.

FIG. 3 is a diagram illustrating an example of an environment in which a robot acts in the first example embodiment.

FIG. 4 is a diagram illustrating an example of a transition system that expresses an action of a robot according to the first example embodiment.

FIG. 5 is a diagram illustrating an example of a structure of an automaton generated by an automaton generation unit according to the first example embodiment.

FIG. 6 is a diagram illustrating an example of an automaton generated by the automaton generation unit according to the first example embodiment.

FIG. 7 is a diagram illustrating an example of an automaton generated by an automaton generation unit according to a second example embodiment.

FIG. 8 is a diagram illustrating an example of a configuration of an information processing device according to a third example embodiment.

FIG. 9 is a diagram illustrating an example of a procedure of processing in an information processing method according to a fourth example embodiment.

FIG. 10 is a schematic block diagram illustrating a configuration of a computer according to at least one example embodiment.

### EXAMPLE EMBODIMENT

While example embodiments of the present invention will be described hereinafter, the following example embodiments do not limit the invention according to the claims. Not all combinations of features described in the example embodiments are essential to the solution of the invention.

### First Example Embodiment

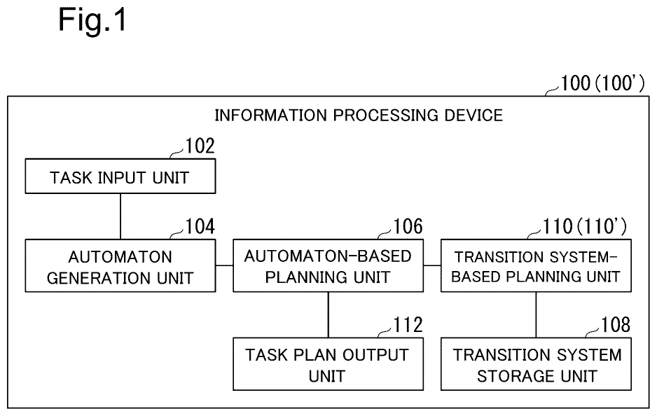

FIG. 1 is a diagram illustrating an example of the configuration of the information processing device according to a first example embodiment. In the configuration illustrated in FIG. 1, an information processing device 100 includes a task input unit 102, an automaton generation unit 104, an automaton-based planning unit 106, a transition system storage unit 108, a transition system-based planning unit 110, and a task plan output unit 112.

The information processing device 100 generates an action plan for a plurality of robots to achieve a given task. The information processing device 100 includes, for example, a personal computer (PC) or workstation (WS).

The task input unit 102 accepts an input of a task in a logical expression format of the linear temporal logic (LTL). The user may input the task, or a device or system different from the information processing device 100 may input the task.

The task received by the task input unit 102 is relevant to an example of a task to be executed.

The linear temporal logic is an aspect temporal logic having an aspect related to time, and various tasks can be expressed by logical expressions. A logical expression of the linear temporal logic is defined using symbols (a logical operator and a temporal mode operator) shown in Expression (1).

$$\begin{matrix}[ Math . 1 ] & \\ ⋀ , ⋁ , ¬ , X , U , F , G & ( 1 )\end{matrix}$$

Here, these symbols are referred to as ∧: And, ∨: Or, ¬: Not, X: Next, U: Until, F: Future, and G: Globally in order from the front.

The meanings of the above symbols are as follows.
a∧b is true when both proposition a and proposition b are true, otherwise false.
a∨b is true when either one of proposition a and proposition b is true, otherwise false.
¬a is false when proposition a is true and true when proposition a is false.
Xa is true when the proposition a is true in the next state, and otherwise it is false. The next state here is a state after one state transition.
aUb is true when the proposition b is true in the current state, or is true when the proposition a is true in all states until a state in which the proposition a is true in the current state and the proposition b is true in the future, and otherwise it is false.
Fa is true when the proposition a is true in at least one current or future state, and otherwise it is false.
Ga is true when the proposition a is true in all states from the present to the future, and otherwise it is false.

Regarding the relationship between the proposition and the logical expression, the proposition may be represented by a logical expression, or the logical expression may be configured as a logical expression including only the proposition.

The automaton generation unit 104 generates an automaton that is a model indicating a state transition in the task to be executed. Specifically, the automaton generation unit 104 converts the logical expression input by the task input unit 102 into an automaton. The automaton generation unit 104 is relevant to an example of an automaton generation means.

The method by which the automaton generation unit 104 converts the logical expression into the automaton is not limited to a specific method. For example, the automaton generation unit 104 may perform this conversion using a known method of converting a logical expression into an automaton.

The automaton output by the automaton generation unit 104 is a model indicating a state transition, and is represented by a state transition diagram by a graph including nodes (Point, vertex) and edges (sides).

Nodes in this graph represent states. This graph has an initial node and a final node. The initial node is relevant to a start point of the graph and represents an initial state. The final node is relevant to the end point of the graph and represents the final state.

An edge in this graph is an arrow (directed edge, directed side) having a direction, and represents a transition from a node to a node. In addition, the edges are assigned labels. This label is relevant to a logical expression representing a given task.

In the automaton generated by the automaton generation unit 104, when an arbitrary edge is selected from the initial node and transitions and reaches the final node, the original logical expression becomes true if labels of the selected edge are arranged in order.

In a case where the original logical expression is a logical expression representing a task that requires infinite repetition, in the automaton generated by the automaton generation unit 104, the original logical expression is true when labels of edges of any path passing through the final node infinitely many times among paths having an infinite length starting from the initial node are arranged in order.

The automaton-based planning unit 106 generates an action plan of the robot based on the automaton generated by the automaton generation unit 104. Generating a plan based on the automaton is also referred to as generating a plan on the automaton.

The automaton-based planning unit 106 is relevant to an example of an automaton-based planning means.

The action plan generated by the automaton-based planning unit 106 is abstract. For example, in a case where it is necessary to achieve all of three tasks A, B, and C obtained by dividing the input task in order to achieve the task, the automaton-based planning unit 106 plans in which order the tasks A, B, and C are executed. In particular, in the planning of the automaton-based planning unit 106, a specific action plan of each robot is not planned. The specific action plan of each robot is generated by the transition system-based planning unit 110 to be described later.

The automaton-based planning unit 106 first selects one of the nodes on the automaton as a start node. The start node is a concept different from an initial node representing a start node of the automaton. Thereafter, the automaton-based planning unit 106 selects, as the goal node, all nodes other than the start node itself in which one edge extends from the selected start node. Then, the automaton-based planning unit 106 acquires the cost required for transition from the start node to each goal node, which is calculated by the transition system-based planning unit 110. The cost required for transition between nodes is also referred to as a cost between nodes.

As described above, the process of calculating the cost required for the transition for each of all the nodes (excluding the node itself of the movement source) movable from a certain node by one transition (one state transition) is also referred to as “development” of the node. In a case where the node is developed, the node of the movement source in the development is also referred to as an “developed” node. A node that has not been developed is also referred to as an “undeveloped” node.

Hereinafter, it is assumed that the automaton-based planning unit 106 can identify whether each node on the automaton has been developed. For example, a development flag indicating whether each node has been developed may be provided.

As the “cost” mentioned here, various indexes indicating that the smaller the value, the better the evaluation on the task execution can be used. For example, the cost may be the time required for the robot to execute the task or the power consumed by the robot. Alternatively, as the index indicating the evaluation on the task execution, an index indicating that the larger the value, the better the evaluation may be used.

Hereinafter, a case where an index indicating that the evaluation on the task execution is better as the value is smaller is used as an index indicating the evaluation on the task execution will be described as an example.

A specific action plan of the robot is required to calculate the cost required for the transition between the nodes, and the transition system-based planning unit 110 calculates the cost as described above.

Therefore, the automaton-based planning unit 106 selects a start node and a goal node, and notifies the transition system-based planning unit 110 of the transition between the selected nodes. The transition system-based planning unit 110 calculates a specific action plan of the robot for transition from the start node to the goal node, and returns the cost required for the transition to the automaton-based planning unit 106. As a result, the automaton-based planning unit 106 obtains the cost between the start node and the goal node which are selected.

The automaton-based planning unit 106 generates a plan on the automaton so as to minimize the cost by repeating the development (selection of start node and goal node, and acquisition of cost) of the nodes. The repetition of the node development performed by the automaton-based planning unit 106 can be regarded as a type of Dijkstra's Algorithm. The Dijkstra's algorithm is one of shortest path planning algorithms. In the Dijkstra's algorithm, the cost of a node that can be directly reached from a certain node is set or updated in order from the node at the start point of the graph, and a path that minimizes the cost from the node at the start point to the node at the end point is detected.

The automaton-based planning unit 106 first allocates a cost to each node as preprocessing. Specifically, the automaton-based planning unit 106 sets the cost of the initial node to 0 and the cost of the other nodes to ∞.

In the development of the nodes, the automaton-based planning unit 106 selects the node with the smallest cost among the undeveloped nodes as the start node.

Then, after developing the start node, the automaton-based planning unit 106 calculates, for each node selected as the goal node, the sum of the cost of the start node and the cost required for transition from the start node to the goal node.

In a case where there is a goal node whose calculated cost is smaller than the current cost, the automaton-based planning unit 106 updates the cost of the goal node to the calculated cost.

In a case where the cost is updated, the automaton-based planning unit 106 registers the start node at that time as a parent node with respect to the goal node where the cost has been updated. That is, the automaton-based planning unit 106 registers a node n1 as the parent node of a node n2 when the cost of the node n2 is updated by the development of the node n1. In a case where the parent node of the node n2 has already been registered, the automaton-based planning unit 106 rewrites the parent node of the node n2 to the node n1.

The automaton-based planning unit 106 repeats the development of nodes and the update of the cost of the goal node. Then, when the final node is selected as the start node in the development of the node, the automaton-based planning unit 106 ends the repetition.

Then, the automaton-based planning unit 106 detects, as the shortest path, a path with the minimum cost among paths from the initial node to the final node on the automaton. For example, the automaton-based planning unit 106 may sequentially follow the parent node from the final node, and may detect, as the shortest path, a reverse arrangement of the nodes reached up to the initial node.

In a case where the task can be achieved only by infinity of repetitions, the automaton-based planning unit 106 calculates, as additional processing, the shortest path starting from the final node and returning to the final node. In this case, after following the shortest path from the initial node to the final node, the automaton-based planning unit 106 sets a path in which the shortest path from the final node to the final node is repeated infinitely as the entire shortest path.

The transition system storage unit 108 stores a transition system that expresses an action of each robot. Similarly to the automaton, the transition system is a model indicating a state transition, and is represented by a state transition diagram by a graph including nodes and edges. The transition system has an initial node but no final node.

In the transition system, labels are assigned to both nodes and edges. The node label indicates a logical expression representing a state related to one robot. The state represented by the node label may be the state of the robot, the state related to the action of the robot, the state of the operating environment of the robot, the state related to the change in the operating environment of the robot, or a combination thereof.

The edge label indicates the action of the robot for making a transition between nodes.

The transition system storage unit 108 stores a transition system for each robot. Therefore, the number of transition systems stored in the transition system storage unit 108 indicates the number of robots. The transition system storage unit 108 also manages the number of robots in this respect.

Alternatively, for the purpose of reducing the data capacity or the like, the transition system storage unit 108 may express robots that perform the same action (state transition) in one transition system. In this case, one transition system may have an initial node for each robot.

The transition system-based planning unit 110 generates an action plan of the robot for making transition from the start node to the goal node selected by the automaton-based planning unit 106 based on the transition system.

The transition system-based planning unit 110 is relevant to an example of a transition system-based planning means.

Hereinafter, in a case where the start node has an edge to itself, the logical expression indicated by the label of this edge is represented by a. A logical expression indicated by the label of the edge from the start node to the goal node is represented by b.

Since calculation becomes complicated if action plans of a plurality of robots are simultaneously generated, the transition system-based planning unit 110 divides the logical expression b into parts that can be executed by one robot. Formally, the transition system-based planning unit 110 converts the logical expression b into a logical expression of a conjunctive normal form as shown in Expression (2).

$$\begin{matrix}[ Math . 2 ] & \\ \begin{matrix}b = {⋀}_{i} {b}_{i} \\ {b}_{i} = {⋁}_{j} {b}_{ij}\end{matrix} \} & ( 2 )\end{matrix}$$

Here, bᵢⱼ is an atomic proposition representing a subdivided task that can be executed by one robot. Thus, the proposition bᵢⱼ is treated as an indivisible proposition any more.

bᵢ is a logical expression obtained by dividing the logical expression b, and when bᵢ (i=1, 2, 3, . . . ) is all true, b is true. That is, when all the tasks represented by the logical expression bᵢ are achieved by the robots, the task represented by the logical expression b is achieved by the robots.

On the other hand, the logical expression bᵢ divided from the logical expression b is true when any one or more of the subdivided propositions bᵢⱼ are true. That is, the logical expression bᵢ is true when any one or more robots have achieved the task indicated by the proposition bᵢⱼ assigned to the robots themselves.

Hereinafter, achieving the task indicated by the logical expression is also referred to as achieving the logical expression. The logical expression here may be an expression indicated by one proposition. Therefore, achieving the task indicated by the proposition is also referred to as achieving the proposition.

In the planning stage, the logical expression or the proposition is achieved on a planned basis. That is, in the planning stage, it is not necessary to actually execute the task (in the real environment).

A method for converting an arbitrary logical expression into a logical expression of a conjunctive normal form is known. The transition system-based planning unit 110 may convert the logical expression b into the logical expression ∧ᵢ∨ᵢbᵢⱼ of the conjunctive normal form using this method. However, the method by which the transition system-based planning unit 110 converts the logical expression b into the logical expression ∧ᵢ∨ⱼbᵢⱼ of the conjunctive normal form is not limited to a specific method.

The transition system-based planning unit 110 divides the task indicated by the logical expression b into a plurality of tasks that can be executed by one robot by the above conversion. Thereafter, the transition system-based planning unit 110 generates the entire action plan for the robot for transition from the start node to the goal node by repeating generation of a plan for one robot by the following procedure.

0. The transition system-based planning unit 110 substitutes (copies) the original logical expression b into the logical expression b′ (temporary variable for calculation).

1. The transition system-based planning unit 110 selects one robot whose plan has not been decided, and generates a plan in which this robot achieves any one of the propositions bᵢⱼ′. The proposition bᵢⱼ′ is obtained by copying the proposition bᵢⱼ to the temporary variable.

At this time, it is assumed that the other robot maintains the current plan, or acts to remain in the current state when the plan is not determined. At the time of this plan, in a case where the start node has an edge to itself, the transition system-based planning unit 110 generates a plan so that the label (logical expression) a is always true.

Also for planning of one robot, the transition system-based planning unit 110 can use a shortest path planning algorithm such as Dijkstra's algorithm. At this time, the goal is any node(s) that achieve the proposition bᵢⱼ′. When the transition system-based planning unit 110 develops a node on the transition system and calculates a cost, it is checked whether the node for which the cost is to be obtained has achieved (true) the label (logical expression) a, and in a case where the label is not achieved, the cost is set to ∞. Since the cost becomes ∞, this node is not selected as the via-point of the shortest path. Conversely, a node passing through the calculated shortest path is always constituted by a node achieving the label a, and the label a is always planned to be true.

2. When a certain proposition bᵢⱼ′ is achieved, the transition system-based planning unit 110 lists up all logical expressions bi′ that become true when the proposition bᵢⱼ′ becomes true, and excludes all the listed propositions bi′ from the logical expression b′ to obtain a new logical expression b′.

For example, when the proposition bᵢⱼ′ is achieved and the proposition bᵢⱼ′ and the proposition bi′j′ are the same proposition, the transition system-based planning unit 110 excludes the logical expression bi comprising the proposition bᵢⱼ′ and the logical expression b_{i′} including the proposition b_{i′j′} from the logical expression b′.

3. The transition system-based planning unit 110 repeats the above 1 to 2 until b′ is empty, and ends the generation of the plan when b′ is empty.

By this procedure, when the end condition that b′ is empty is satisfied, the logical expression b is achieved by the action plan for each robot generated so far.

Then, the transition system-based planning unit 110 calculates the cost of the action plan indicated by the logical expression b and outputs the cost to the automaton-based planning unit 106. Although not described in the description of the automaton-based planning unit 106, the transition system-based planning unit 110 also outputs the action plan of each robot for achieving the logical expression b to the automaton-based planning unit 106 in association with the cost. The action plan of each robot for achieving the logical expression b is the action plan of each robot obtained when b′ is empty in the above procedure.

The action plan of each robot for achieving the logical expression b is used for generating the entire action plan of the robot for achieving the input task output by the task plan output unit 112. As described above, the automaton-based planning unit 106 detects a path with the minimum cost among paths from the initial node to the final node on the automaton. Then, the automaton-based planning unit 106 generates, as the entire action plan of the robot for achieving the input task, an arrangement of action plans of the robots for achieving the transition indicated by the edge constituting the detected path in order of the detected path.

The entire action plan of the robot for achieving the input task is also referred to as a task plan.

The action plan of each robot for achieving the logical expression b is also used for setting an initial state (start node) on the transition system when the current goal node on the automaton is selected as the next start node. The transition system-based planning unit 110 sets the state on the transition system after the transition from the current start node to the goal node on the automaton as an initial state on the transition system when the transition from the next start node to the goal node on the automaton is made.

In the above description, the case where the transition system-based planning unit 110 generates the action plan one by one has been described as an example, but the transition system-based planning unit 110 may generate the action plan for each group obtained by dividing the entire robots. For example, the transition system-based planning unit 110 may sequentially generate an action plan for each group of two robots. Alternatively, the transition system-based planning unit 110 may sequentially generate an action plan for each group of three robots.

The transition system-based planning unit 110 generates an action plan not for each robot but for each group of robots, so that the amount of calculation increases, but there is a possibility that a more efficient action plan can be calculated. By the transition system-based planning unit 110 generating an action plan for each group of robots, it is expected that tasks that cannot be achieved by only one robot, such as two robots holding both ends of a load and carrying the load, can be achieved.

The task plan output unit 112 outputs the plan calculated by the automaton-based planning unit 106 as a task plan. That is, the task plan output unit 112 outputs, as a task plan, an entire action plan of the robot in which action plans of the robots (on the transition system) relevant to the transitions are arranged in order of the path from the initial node to the final node on the automaton.

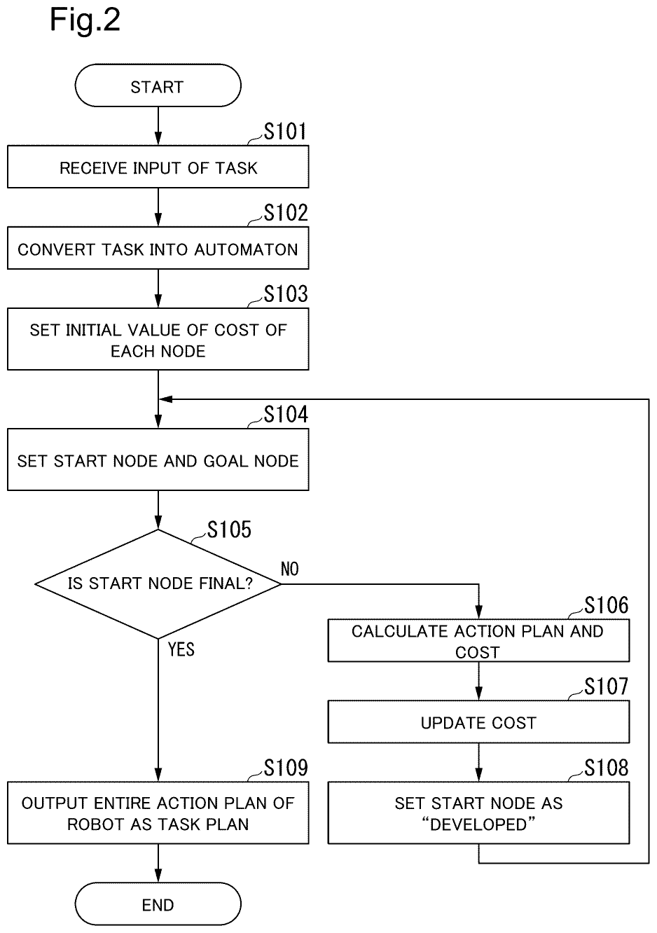

FIG. 2 is a diagram illustrating an example of a procedure of processing performed by the information processing device 100.

In the processing illustrated in FIG. 2, the task input unit 102 receives an input of a task in the form of a logical expression of linear temporal logic from a user, another system, or the like (step S101).

Next, the automaton generation unit 104 converts the task (logical expression) received by the task input unit 102 into an automaton (step S102).

Next, the automaton-based planning unit 106 sets an initial value of the cost for each node of the automaton as preprocessing (step S103). Specifically, the automaton-based planning unit 106 sets the cost 0 to the initial node and sets the cost of to the other nodes.

Next, the automaton-based planning unit 106 sets, as a start node, a node that has the minimum cost on the automaton and has not been developed, and sets, as a goal node, each node that can be reached by one edge from the start node (step S104).

Next, the automaton-based planning unit 106 determines whether the start node is a final node (step S105).

In a case where the automaton-based planning unit 106 determines that the start node is not the final node (step S105: NO), the transition system-based planning unit 110 calculates, for each goal node, an entire action plan and its cost for the robot for achieving a logical expression from the start node to the goal node of the automaton using the transition system stored in the transition system storage unit 108 (step S106).

Next, the automaton-based planning unit 106 determines whether it is necessary to update the cost for each goal node, and updates the cost of the goal node determined to be required to be updated (step S107). Specifically, for each goal node, the automaton-based planning unit 106 determines whether the sum of the cost of the start node and the cost required for transition from the start node to the goal node is smaller than the cost set for the goal node. In a case where it is determined that the sum of the costs is smaller than the cost set for the goal node, the automaton-based planning unit 106 sets the calculated cost as the cost of the goal node.

Next, the automaton-based planning unit 106 determines that the start node has been developed (step S108).

After step S108, the process returns to step S104.

On the other hand, when the automaton-based planning unit 106 determines in step S105 that the start node is the final node (step S105: YES), the task plan output unit 112 outputs, as a task plan, an entire action plan of the robot in which action plans of the robots relevant to the transitions are arranged in order of the path from the initial node to the final node (step S109).

After step S109, the information processing device 100 ends the processing of FIG. 2.

The processing in FIG. 2 can be changed without departing from the gist of the present invention.

For example, in step S106 of FIG. 2, the automaton-based planning unit 106 may output each goal node relevant to the start node to the transition system-based planning unit 110, and collectively acquire the calculated action plan of each goal node and its cost. Alternatively, the automaton-based planning unit 106 may repeat a process of outputting the start node and the goal node to the transition system-based planning unit 110 for each pair of the start node and the goal node, and acquiring the calculated action plan and its cost.

### First Operation Example

Next, a specific operation of the information processing device 100 will be described using an example of a watching robot.

First, a transition system that expresses the action of the watching robot stored in the transition system storage unit 108 will be described. The transition system can be expressed about the robot's action and also about the environment.

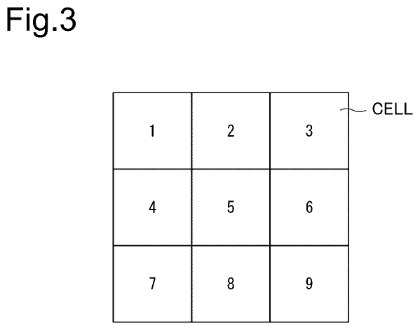

FIG. 3 is a diagram illustrating an example of an environment in which the robot acts. This environment has nine cells in the grid. The robot goes back and forth between these nine cells and performs monitoring (patrol). The nine cells are referred to as a cell 1, . . . , and a cell 9.

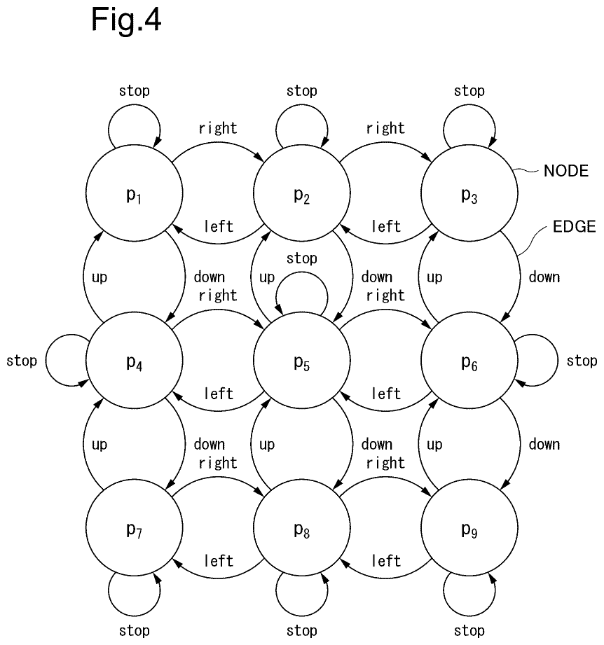

FIG. 4 is a diagram illustrating an example of a transition system that expresses the action of the robot. FIG. 4 illustrates an example in which the action of the watching robot in the environment of FIG. 3 is expressed by the transition system.

The node's label pᵢ (i=1, . . . , 9) indicates that the robot is in the cell i. pᵢ is also treated as a proposition, and that the robot is in the cell i is also referred to as pᵢ being established or pᵢ being true. pᵢ is also referred to as position information of the robot.

The label of the edge represents the action of the robot. “stop” indicates that the robot stays in the same cell. “up”, “down”, “left”, and “right” indicate that the robot moves up, down, left, and right.

In the first operation example, it is assumed that there are two robots 1 and 2, and the initial positions of the robots are all the cell 1. Therefore, it is assumed that p₁ is satisfied in the initial state.

In the transition system of FIG. 4, the display of the initial state of the robot is omitted.

It is considered that all the cells 1 to 9 are periodically monitored as the task received by the task input unit 102. This task can be expressed by a logical expression shown in Expression (3).

$$\begin{matrix}[ Math . 3 ] & \\ G ( {⋀}_{i = 1 , … , 9} {Fp}_{i} ) & ( 3 )\end{matrix}$$

In this logical expression, Fpᵢ becomes true when the robot is in the cell i at some point in the future. That is, Fpᵢ becomes true when pᵢ is true at some point in the future. Therefore, Fpᵢ represents an instruction “go to the cell i and monitor from now on”.

The fact that the looking-around indicated by Fpᵢ is performed for all the cells 1 to 9 can be expressed as Expression (4).

$$\begin{matrix}[ Math . 4 ] & \\ {⋀}_{i = 1 , … , 9} {Fp}_{i} & ( 4 )\end{matrix}$$

The logical expression ∧_{i=1, . . . , 9}Fpᵢ shown in Expression (4) indicates that “perform instruction to go to the cell i and monitor for all cells 1 to 9”. Therefore, a logical expression G(∧_{i=1, . . . , 9}Fpᵢ) obtained by adding “G” to this logical expression represents “Always perform the instruction to go to all cells 1 to 9 and monitor from now on (repeat infinitely)”. As described above, the logical expression G(∧_{i=1, . . . , 9}Fpᵢ) represents a task of periodically circulating and monitoring all cells 1 to 9.

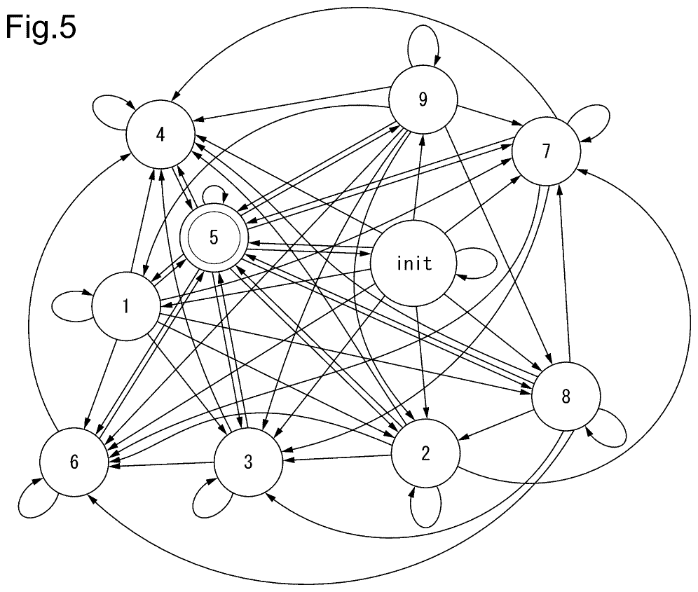

FIG. 5 is a diagram illustrating an example of a structure of an automaton generated by the automaton generation unit 104.

The automaton generation unit 104 converts the logical expression G(∧_{i=1, . . . , 9}Fpᵢ) into an automaton having a structure illustrated in FIG. 5. This conversion can be performed using, for example, LTL 2 BA: fast translation from LTL formulae to Buchi automata (http://www.lsv.fr/~gastin/lt12ba/). However, as described above, the method by which the automaton generation unit 104 converts the logical expression into the automaton is not limited to a specific method.

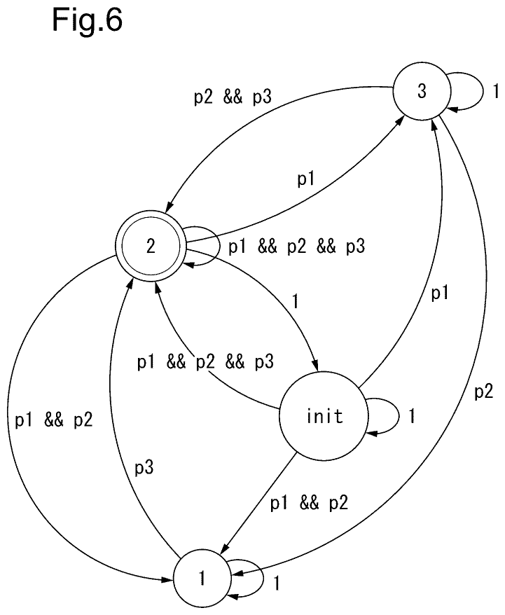

In FIG. 5, the display of the label is omitted in order to avoid difficulty in viewing the drawing. In order to show the label of the automaton in the drawing, a simpler task of periodically monitoring all of the cells 1 to 3 is converted into the automaton by the automaton generation unit 104 in FIG. 6. Hereinafter, a task limited to the cells 1 to 3 is used as an example for easy understanding of the description.

In the automaton of FIG. 6, a node written as init is an initial node, and a node 2 indicated by a double circle is a final node. The label with “1” of the edge is a label indicating that it is always true (True). The symbol written as “&&” in the label of the edge means AND and has the same meaning as ∧.

The automaton-based planning unit 106 executes the algorithm illustrated in FIG. 2 based on the automaton illustrated in FIG. 6. In step S103 of FIG. 2, the automaton-based planning unit 106 sets cost 0 to the initial node and sets cost ∞ to the other nodes as preprocessing.

In step S104 of FIG. 2, the automaton-based planning unit 106 selects a node with the lowest cost as a start node. Here, the automaton-based planning unit 106 selects the initial node with the cost 0 as the start node. Then, the automaton-based planning unit 106 selects a node adjacent to the start node as a goal node. Here, the automaton-based planning unit 106 selects the nodes 1 to 3 as the goal nodes.

The automaton-based planning unit 106 outputs information indicating the selected initial node as the start node and the selected nodes 1 to 3 as the goal nodes to the transition system-based planning unit 110. The automaton-based planning unit 106 outputs an initial value (information indicating that the robot 1 is in the cell 1 and information indicating that the robot 2 is in the cell 1) of the action plan in the start node to the transition system-based planning unit 110. The robot being in the cell 1 is represented by the proposition p₁.

The transition system-based planning unit 110 first sets the start node as the initial node and the goal node as the node 1.

Referring to FIG. 6, the label a=1 of the edge from the start node to itself, and the label b=p₁∧p₂ of the edge from the start node to the goal node.

The transition system-based planning unit 110 converts b into the format shown in Expression (5) in accordance with the format of Expression (2) described above.

$$\begin{matrix}[ Math . 5 ] & \\ \begin{matrix}b = {⋀}_{i = 1 , 2} {b}_{i} \\ {b}_{i} = {⋁}_{j = 1} {p}_{i}\end{matrix} \} & ( 5 )\end{matrix}$$

∨ⱼ₌₁pᵢ in Expression (5) is ∨ⱼ₌₁pᵢ=pᵢ. Therefore, Expression (5) represents the same logical expression b=p₁∧p₂ as before the conversion.

The b=p₁∧p₂ before conversion is already divided into propositions p₁ and p₂ that can be executed by one robot. Therefore, the transition system-based planning unit 110 may omit the conversion from b=p₁∧p₂ to Expression (5).

The transition system-based planning unit 110 performs calculation as follows according to the above-described procedure.

0. The transition system-based planning unit 110 substitutes the original logical expression b into the logical expression b′. That is, b′=p₁∧p₂.

1. The transition system-based planning unit 110 selects one robot whose plan has not been decided, and generates a plan in which this robot achieves any one of the propositions bᵢⱼ′. Here, a=1 is true regardless of the action of the robot, and thus, there is no need to consider it. The transition system-based planning unit 110 selects the robot 1 and generates a plan to achieve any of bᵢⱼ′, that is, p₁ or p₂. The transition system-based planning unit 110 plans stop because p₁ can be achieved if the robot 1 stays on the spot.

2. When a certain proposition bᵢⱼ′ is achieved, the transition system-based planning unit 110 lists up all logical expressions bi′ that become true when the proposition bᵢⱼ′ becomes true, and excludes the logical expressions bi′ from the logical expression b′ to obtain a new logical expression b′. That is, b′=p₂.

3. According to the procedure so far, the transition system-based planning unit 110 plans the action of the robot 1 as stop. Since b′ is not yet empty, the transition system-based planning unit 110 repeats the procedures 1 to 2.

1. The transition system-based planning unit 110 selects one robot whose plan has not been decided, and generates a plan in which this robot achieves any one of bᵢⱼ′. Since only the robot 2 remains, the transition system-based planning unit 110 selects the robot 2. Since bᵢⱼ′ is only p₂, the transition system-based planning unit 110 generates a plan to achieve p₂. Since p₂ can be achieved if the robot 2 moves to the right, the transition system-based planning unit 110 plans right.

2. The transition system-based planning unit 110 excludes p₂ from b′ and sets b′=φ.

3. Since b′ is empty, the transition system-based planning unit 110 terminates the generation of the plan.

According to the above procedure, the transition system-based planning unit 110 generates an action plan in which the robot 1 takes stop and the robot 2 takes right. The cost of the action here is the number of movements of the robot, that is, the number of up, down, left, or right. The transition system-based planning unit 110 calculates the cost as 1 in this action plan.

The transition system-based planning unit 110 also plans the action of the robot in a case where the start node is the initial node and the goal node is the node 2.

When the goal node is the node 2, b=p₁∧p₂∧p₃, and two robots need to exist simultaneously in each of the cells 1 to 3. However, since one robot can exist only in one place at the same time, the transition system-based planning unit 110 cannot make this action plan. Therefore, the transition system-based planning unit 110 sets the cost of this plan to ∞.

The transition system-based planning unit 110 also plans the action of the robot in a case where the start node is the initial node and the goal node is the node 2.

When the goal node is the node 3, only b=pᵢ needs to be achieved. Therefore, the transition system-based planning unit 110 generates an action plan with the robot 1 as stop. The transition system-based planning unit 110 sets the cost of this plan to 0.

The transition system-based planning unit 110 returns the action plan and the cost for each pair of the start node and the goal node to the automaton-based planning unit 106.

The automaton-based planning unit 106 updates the cost of the goal node based on the cost of the action plan acquired from the transition system-based planning unit 110. As a result, the automaton-based planning unit 106 updates the cost of the node 1 to 1 and updates the cost of the node 3 to 0. On the other hand, since the cost of the node 2 does not fall below the original ∞, the cost is not updated.

After the process of updating the cost of the node, the automaton-based planning unit 106 determines that the initial node that has been the start node has been developed.

Since the development of the initial node is completed, the automaton-based planning unit 106 selects, as the start node, the node 3 having the minimum cost 0 among the undeveloped nodes. Then, the automaton-based planning unit 106 selects each of the undeveloped nodes 2 and 1 adjacent to the node 3 as a goal node. The automaton-based planning unit 106 outputs information indicating the selected start node (node 3) and goal node (nodes 2 and 1) to the transition system-based planning unit 110.

The automaton-based planning unit 106 outputs the position information of the robot at the start node to the transition system-based planning unit 110 as an initial value (initial state) of the action plan. In the transition from the initial node to the node 3, the robot 1 is located in the cell 1 by stop. Since the robot 2 is not caused to act, the robot 2 is located in the cell 1. Therefore, the automaton-based planning unit 106 outputs the position information p₁ of the robot 1 and the position information p₁ of the robot 2 to the transition system-based planning unit 110.

When the start node is the node 3 and the goal node is the node 2, p₂ and p₃ may be achieved. Therefore, the transition system-based planning unit 110 plans actions in which the robot 1 is right (moving from the cell 1 to the cell 2) and the robot 2 is right and right (moving from the cell 1 to the cell 2, and moving from the cell 2 to the cell 3). The transition system-based planning unit 110 calculates the cost of this action plan as 3.

When the start node is the node 3 and the goal node is the node 1, p₂ may be achieved. Therefore, the robot 1 plans an action of right (moving from the cell 1 to the cell 2). The transition system-based planning unit 110 calculates the cost of this action plan as 1.

The transition system-based planning unit 110 returns the action plan and the cost for each pair of the start node and the goal node to the automaton-based planning unit 106.

The automaton-based planning unit 106 updates the cost of the goal node based on the cost of the action plan acquired from the transition system-based planning unit 110.

Regarding the node 2, the cost of the node 3, which is a start node, is 0, the cost of the action plan from the node 3 to the node 2 is 3, and the sum of 3 is less than the original cost ∞ of the node 2. Therefore, the automaton-based planning unit 106 updates the cost of the node 2 to 3.

On the other hand, regarding the node 3, the cost of the node 3, which is a start node, is 0, the cost of the action plan from the node 3 to the node 1 is 1, and the sum of 1 is not less than the original cost 1 of the node 1. Therefore, the automaton-based planning unit 106 does not update the cost of the node 1 and keeps the cost as it is.

After the process of updating the cost of the node, the automaton-based planning unit 106 determines that the node 3 that has been the start node has been developed.

Since the development of the node 3 is completed, the automaton-based planning unit 106 selects, as the start node, the node 1 having the minimum cost 1 among the undeveloped nodes. Then, the automaton-based planning unit 106 selects each of the undeveloped node 2 adjacent to the node 1 as a goal node. The automaton-based planning unit 106 outputs information indicating the selected start node (node 1) and goal node (node 2) to the transition system-based planning unit 110.

Since the cost of the developed node 3 is 0 and is equal to or less than the cost of the node 1 which is a start node, there is no possibility that the cost of the node 3 is updated. Therefore, the automaton-based planning unit 106 does not select the developed node (the node 3 in this case) as the goal node.

The automaton-based planning unit 106 outputs the position information of the robot at the start node to the transition system-based planning unit 110 as an initial value (initial state) of the action plan. In the transition from the node 3 to the node 1, the robot 1 is located in the cell 1 by stop. The robot 2 is located in the cell 2 by right. Therefore, the automaton-based planning unit 106 outputs the position information p₁ of the robot 1 and the position information p₂ of the robot 2 to the transition system-based planning unit 110.

When the start node is the node 1 and the goal node is the node 2, p₃ may be achieved. The transition system-based planning unit 110 plans an action in which the robot 2 is right (moving from the cell 2 to the cell 3) based on the position information of the robot acquired from the automaton-based planning unit 106. The transition system-based planning unit 110 calculates the cost of this action plan as 1.

The transition system-based planning unit 110 returns the action plan and the cost for each pair of the start node and the goal node to the automaton-based planning unit 106. Here, the transition system-based planning unit 110 returns the action plan and the cost of only one pair of the start node=node 1 and the goal node=node 2 to the automaton-based planning unit 106.

The automaton-based planning unit 106 updates the cost of the goal node based on the cost of the action plan acquired from the transition system-based planning unit 110.

The cost of the node 1, which is the start node, is 1, the cost of the action plan from the node 1 to the node 2 is 1, and the sum of 2 is less than the original cost 3 of the node 2. Therefore, the automaton-based planning unit 106 updates the cost of the node 2 to 2.

After the process of updating the cost of the node, the automaton-based planning unit 106 determines that the node 1 that has been the start node has been developed.

Since the development of the node 1 is completed, the automaton-based planning unit 106 selects the node 2 remaining as an undeveloped node as a start node. Since the node 2 is a final node, the end condition is satisfied, and the information processing device 100 ends the process of generating the action plan.

As described above, on the automaton, the automaton-based planning unit 106 prepares a plan of initial node→node 1→node 2. On the transition system, the transition system-based planning unit 110 prepares an action plan in which the robot 1 takes actions of stop and stop and the robot 2 takes actions of right and right. The transition system-based planning unit 110 or the automaton-based planning unit 106 may fill the unplanned part of the robot's action with an action to maintain the current state, that is, stop.

The task plan output unit 112 outputs the action plan of the robot as a task plan. That is, the task plan output unit 112 outputs action plans in which the robot 1 takes stop and stop and the robot 2 takes right and right.

As described above, the automaton generation unit 104 generates the automaton that is the model indicating the state transition in the task to be executed. The automaton-based planning unit 106 generates an action plan based on the automaton. The transition system-based planning unit 110 generates an action plan of the robot for executing an action plan based on the automaton based on the transition system which is a model indicating a state transition by the action of the robot.

As a result, the automaton-based planning unit 106 can generate an action plan obtained by dividing the task to be executed by generating an action plan by a combination of state transitions on the automaton. The transition system-based planning unit 110 is only required to generate an action plan of the robot for each of state transitions on the automaton into which the task to be executed is divided.

As described above, according to the information processing device 100, the action plan of the robot can be generated for a simpler task (state transition on the automaton) in which the task to be executed is divided. In this regard, according to the information processing device 100, even in a case where the number of robots is relatively large, it is expected that the time required for generating the action plan is relatively short.

Here, in task planning in a multi-agent system, generally, the amount of calculation increases exponentially with an increase in the number of robots, which is known as a problem that is difficult to calculate. The multi-agent system referred to herein is a system in which a plurality of robots cooperate. Task planning is to prepare an action plan for achieving a task.

On the other hand, in the information processing device 100, since it is sufficient to generate an action plan of the robot for a task simpler than the task to be executed, even in a case where the number of robots is relatively large, an increase in time required for the action plan for achieving each task is limited, and it is expected that the time required for generating the entire action plan is relatively short.

In particular, the transition system-based planning unit 110 generates an action plan for a task divided so as to be achieved by one robot, whereby the time required for the transition system-based planning unit 110 to generate the action plan can be made linear with respect to the number of robots.

The automaton generation unit 104 generates an automaton indicated by a graph including a node indicating a state and a directed edge indicating a state transition. The automaton-based planning unit 106 specifies a transition between two nodes in an automaton in generation of an action plan based on the automaton. The transition system-based planning unit 110 generates an action plan of the robot for making the specified transition.

As a result, the transition system-based planning unit 110 may generate an action plan of the robot for each state transition on the automaton. According to the information processing device 100, in this respect, the task to be executed can be divided relatively easily.

The transition system-based planning unit 110 divides a task for performing the specified transition into tasks achievable by one robot, assigns each of the tasks achievable by one robot to one robot, and generates an action plan for achieving the task by the robot based on the transition system, thereby generating an entire action plan for the robot for making the specified transition.

In this manner, the transition system-based planning unit 110 can generate an action plan for a divided task so that the task can be achieved by one robot. As a result, according to the information processing device 100, the time required for the transition system-based planning unit 110 to generate the action plan can be made linear with respect to the number of robots.

The automaton generation unit 104 generates, for each edge, an automaton to which a label indicating a task for making the transition indicated by the edge is attached.

As a result, the transition system-based planning unit 110 may generate an action plan of the robot for achieving the task indicated by the label attached to the edge of the automaton. According to the information processing device 100, in this respect, the task to be executed can be divided relatively easily.

The transition system is illustrated by a graph including a node indicating a state related to an action of one robot and an edge indicating a state transition by the action of the robot. The transition system-based planning unit 110 reads, from the transition system, a robot's action for making a state transition by execution of a task achievable by one robot, thereby generating an action plan for the robot to achieve the task.

In this manner, the transition system-based planning unit 110 can generate an action plan of the robot by reading out the action of the robot from the transition system. According to the information processing device 100, in this respect, the transition system-based planning unit 110 can relatively simplify the process of generating the action plan of the robot, and the time required for the transition system-based planning unit 110 to generate the action plan of the robot is expected to be relatively short.

The automaton-based planning unit 106 generates an action plan based on the automaton by obtaining a path with the lowest cost among paths from a start point (initial node) to an end point (final node) on the automaton.

According to the information processing device 100, various indexes indicating evaluation regarding task execution can be used as costs, and an action plan that improves the evaluation regarding task execution can be generated.

The task is represented by a logical expression of linear temporal logic.

According to the information processing device 100, the task can be divided by expressing the logical expression indicating the task to be executed in the conjunctive normal form. According to the information processing device 100, in this respect, the task to be executed can be divided relatively easily.

### Second Example Embodiment

In the second example embodiment, processing in which the information processing device generates a more efficient action plan of a robot will be described.

The configuration of the information processing device according to the second example embodiment is similar to that of the first example embodiment. In the second example embodiment, FIG. 1 is used as a configuration diagram of the information processing device. In the second example embodiment, the information processing device is referred to as an information processing device 100′, and the transition system-based planning unit is referred to as a transition system-based planning unit 110′.

The transition system-based planning unit 110′ is relevant to an example of a transition system-based planning means.

The task input unit, the automaton generation unit, the automaton-based planning unit, the transition system storage unit, and the task plan output unit are denoted by the same reference numerals (102, 104, 106, 108, 112) as those in the first example embodiment, and a detailed description thereof will be omitted here.

In the information processing device 100′, processing performed by the transition system-based planning unit 110′ is different from the case of the transition system-based planning unit 110 of the information processing device 100. In other respects, the information processing device 100′ is similar to the information processing device 100. FIG. 2 is used as a flowchart illustrating an example of a processing procedure of the information processing device 100′.

As described above, in the first example embodiment, when the transition system-based planning unit 110 generates an action plan of the robot for moving from the start node to the goal node, it is conceivable to set an action that stays in the current state, such as stop, in an unplanned portion.

On the other hand, in the second example embodiment, the transition system-based planning unit 110′ registers an unplanned portion as a flex (Flex, Flexible) plan and updates the flex plan. As a result, the information processing device 100′ prepares a more efficient action plan of the robot such as an action plan in which the number of steps required to achieve a given task (the number of times of state transition on the automaton) is relatively small.

A portion other than the flex plan in the action plan (in particular, an action plan in the middle of generation) generated by the transition system-based planning unit 110′ is referred to as a static plan.

Specifically, when the transition system-based planning unit 110′ generates an action plan for each robot for achieving the state transition on the automaton, the action plan generated by reading the action of the robot for executing the state transition from the transition system is a non-rewritable static plan.

On the other hand, for a robot for which it is not necessary to define an action in order to execute the state transition on the automaton, the transition system-based planning unit 110′ sets the action plan of the robot as a rewritable flex plan. The transition system-based planning unit 110′ may temporarily set, as the flex plan, an action that remains in the current state, such as stop.

The transition system-based planning unit 110′ registers the flex plan and treats the flex plan as a target to be rewritten later.

The transition system-based planning unit 110′ acquires information indicating the transition from the start node to the goal node from the automaton-based planning unit 106, and detects a flex plan included in an action plan of each robot from the initial node to the start node when generating an action plan of the robot for executing the transition. In a case where a flex plan is found and changing that flex plan can plan the robot's action, or a portion thereof, to make the transition from the start node to the goal node, then the transition system-based planning unit 110′ can change that flex plan.

In this manner, the transition system-based planning unit 110′ can change the action plan before the start node.

### Second Operation Example

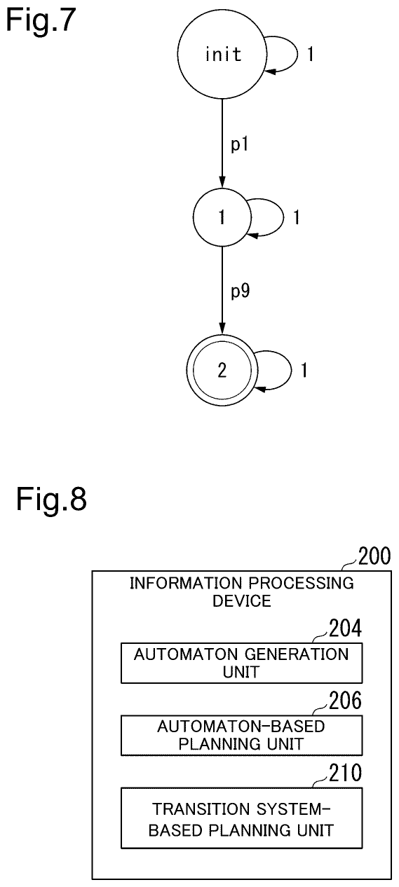

Next, a specific operation of the information processing device 100′ will be described using the environment illustrated in FIG. 3, the transition system illustrated in FIG. 4, and the automaton illustrated in FIG. 7.

In the second operation example, it is assumed that there are two robots 1 and 2, and the initial positions of the two robots are all cell 5. The robot being located in the cell 5 is represented by p₅.

The transition system-based planning unit 110′ generates an action plan for moving the robot 1 from the cell 5 to the cell 1 with respect to the transition from the initial node to the node 1 on the automaton. The robot being located in the cell 1 is represented by p₁.

Specifically, the transition system-based planning unit 110′ generates an action plan in which the robot 1 acts as up and left. Here, the cost is the number of steps until arrival at the destination. The transition system-based planning unit 110′ calculates the cost of the action plan in this case as 2.

Here, the transition system-based planning unit 110′ generates an action plan as follows.
Static plan: Robot 1 (up, left)
Flex plan: Robot 2 (stop, stop)

Next, the transition system-based planning unit 110′ generates an action plan for moving the robot 2 from the cell 5 to the cell 9 with respect to the transition from the node 1 to the node 2 on the automaton. The robot being located in the cell 9 is represented by p₉.

Specifically, the transition system-based planning unit 110′ generates an action plan in which the robot 2 acts as down and right. At that time, by rewriting the previous flex plans stop and stop of the robot 2 to down and right, an action plan in which the robot 2 acts as down and right is generated.

As a result, when the state on the automaton arrives at the node 1, the robot 2 is already located at the node 9. Thus, the transition from the node 1 to the node 2 on the automaton can be achieved without both the robots 1 and 2 having to take new actions. Since the action of the robot is unnecessary, the transition system-based planning unit 110′ calculates the cost of the transition from the node 1 to the node 2 on the automaton as 0.

Through the above procedure, the task plan output unit 112 outputs, as a task plan, an action plan in which the robot 1 acts up and left and the robot 2 acts down and right.

Here, for comparison with the information processing device 100′, a case where the information processing device 100 generates an action plan in the situation of the second operation example will be considered. Here, it is assumed that the transition system-based planning unit 110 of the information processing device 100 does not rewrite the generated action plan. In this case, the information processing device 100 generates an action plan in which the robot 1 acts as up, left, stop, and stop, and the robot 2 acts as stop, stop, down, and right.

The cost of the action plan generated by the information processing device 100 is 4, whereas the cost of the action plan generated by the information processing device 100′ is 2.

As described above, according to the information processing device 100′, by rewriting the generated flex plan, it is possible to generate an efficient action plan of the robot more than a case where the action plan is not rewritten.

As described above, in the entire action plan for the robot for making the transition between the nodes of the automaton, the transition system-based planning unit 110′ plans the action of the robot other than the action for making the transition between the nodes of the automaton among the actions of each robot as a flex plan that is a rewritable plan. In a case where the transition system-based planning unit 110′ determines that the transition between the nodes of the automaton that is the target of the plan can be made by rewriting the flex plan included in the planned action plan, the transition system-based planning unit generates an entire action plan for the robot for making the transition between the nodes of the automaton that is the target of the plan by rewriting the flex plan.

According to the information processing device 100′, by rewriting the flex plan, it is expected that an efficient action plan of the robot can be generated as compared with a case where the action plan is not rewritten.

### Third Example Embodiment

FIG. 8 is a diagram illustrating an example of the configuration of the information processing device according to a third example embodiment. In the configuration illustrated in FIG. 8, an information processing device 200 includes an automaton generation unit 204, an automaton-based planning unit 206, and a transition system-based planning unit 210.

With this configuration, the automaton generation unit 204 generates the automaton that is the model indicating the state transition in the task to be executed. The automaton-based planning unit 206 generates an action plan based on the automaton. The transition system-based planning unit 210 generates an action plan of the robot for executing an action plan based on the automaton based on the transition system which is a model indicating a state transition by the action of the robot.

The automaton generation unit 204 is relevant to an example of an automaton generation means. The automaton-based planning unit 206 is relevant to an example of an automaton-based planning means. The transition system-based planning unit 210 is relevant to an example of a transition system-based planning means.

As a result, the automaton-based planning unit 206 can generate an action plan obtained by dividing the task to be executed by generating an action plan by a combination of state transitions on the automaton. The transition system-based planning unit 210 is only required to generate an action plan of the robot for each of state transitions on the automaton into which the task to be executed is divided.

As described above, according to the information processing device 200, the action plan of the robot can be generated for a simpler task (state transition on the automaton) in which the task to be executed is divided. In this regard, according to the information processing device 200, even in a case where the number of robots is relatively large, it is expected that the time required for generating the action plan is relatively short.

In particular, the transition system-based planning unit 210 generates an action plan for a task divided so as to be achieved by one robot, whereby the time required for the transition system-based planning unit 210 to generate the action plan can be made linear with respect to the number of robots.

The automaton generation unit 204 can be achieved by using, for example, the functions of the automaton generation unit 104 and the like illustrated in FIG. 1. The automaton-based planning unit 206 can be achieved by using, for example, the functions of the automaton-based planning unit 106 and the like illustrated in FIG. 1. The transition system-based planning unit 210 can be achieved by using functions such as the transition system-based planning unit 110 or the transition system-based planning unit 110′ illustrated in FIG. 1, for example.

### Fourth Example Embodiment

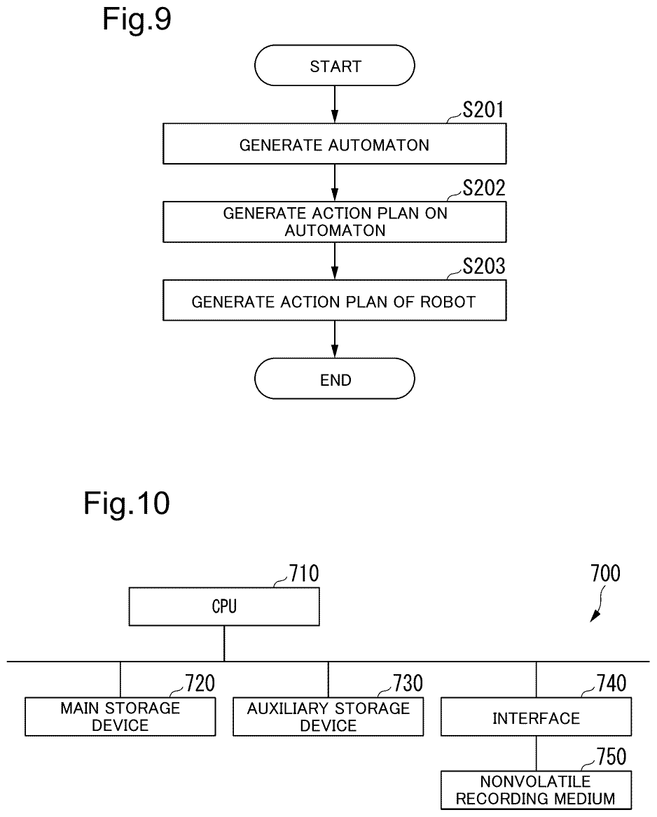

FIG. 9 is a diagram illustrating an example of a procedure of processing in an information processing method according to a fourth example embodiment. The information processing method illustrated in FIG. 9 includes generating an automaton (step S201), generating an action plan on the automaton (step S202), and generating an action plan of a robot (step S203).

In generating an automaton (step S201), a computer generates an automaton that is a model indicating a state transition in a task to be executed. In generating an action plan on the automaton (step S202), the computer generates an action plan based on the automaton. In generating the action plan of the robot (step S203), the computer generates the action plan of the robot for executing the action plan based on the automaton based on the transition system that is a model indicating the state transition by the action of the robot.

According to the information processing method illustrated in FIG. 9, by generating an action plan by a combination of state transitions on the automaton, it is possible to generate an action plan obtained by dividing a task that is an execution target. As a result, the action plan of the robot may be generated for each of the state transitions on the automaton in which the task to be executed is divided.

As described above, according to the information processing method illustrated in FIG. 9, the action plan of the robot can be generated for a simpler task (state transition on the automaton) in which the task to be executed is divided. According to the information processing method illustrated in FIG. 9, in this respect, even in a case where the number of robots is relatively large, it is expected that the time required for generating the action plan is relatively short.

In particular, according to the information processing method illustrated in FIG. 9, by generating an action plan for a task divided so as to be achieved by one robot, the time required for the transition system-based planning unit 210 to generate the action plan can be made linear with respect to the number of robots.

FIG. 10 is a schematic block diagram illustrating a configuration of a computer according to at least one example embodiment.

In the configuration illustrated in FIG. 10, a computer 700 includes a central processing unit (CPU) 710, a main storage device 720, an auxiliary storage device 730, an interface 740, and a nonvolatile recording medium 750.

Any one or more of the information processing device 100, the information processing device 100′, and the information processing device 200 described above may be implemented in the computer 700. In this case, the operation of each processing unit described above is stored in the auxiliary storage device 730 in the form of a program. The CPU 710 reads the program from the auxiliary storage device 730, develops the program in the main storage device 720, and executes the above processing according to the program. The CPU 710 secures a storage area related to each of the above-described storage units in the main storage device 720 according to the program. Communication between each device and another device is executed by the interface 740 having a communication function and performing communication under the control of the CPU 710.

In a case where the information processing device 100 is implemented in the computer 700, the operations of the task input unit 102, the automaton generation unit 104, the automaton-based planning unit 106, the transition system-based planning unit 110, and the task plan output unit 112 are stored in the auxiliary storage device 730 in the form of a program. The CPU 710 reads the program from the auxiliary storage device 730, develops the program in the main storage device 720, and executes the above processing according to the program.

In accordance with the program, the CPU 710 secures a storage area for the information processing device 100 to perform processing, such as a storage area for the transition system storage unit 108, in the main storage device 720.

The output of the task plan output unit 112 of the information processing device 100 is executed by the interface 740 having an output function such as a communication function or a display function and performing output processing under the control of the CPU 710. Communication between the information processing device 100 and another device is executed by allowing the interface 740 having a communication function to be operated under the control of the CPU 710. The interaction between the information processing device 100 and the user is executed by the interface 740 having a display device and an input device and operating under the control of the CPU 710.

In a case where the information processing device 100′ is implemented in the computer 700, the operations of the task input unit 102, the automaton generation unit 104, the automaton-based planning unit 106, the transition system-based planning unit 110′, and the task plan output unit 112 are stored in the auxiliary storage device 730 in the form of a program. The CPU 710 reads the program from the auxiliary storage device 730, develops the program in the main storage device 720, and executes the above processing according to the program.

In accordance with the program, the CPU 710 secures a storage area for the information processing device 100′ to perform processing, such as a storage area for the transition system storage unit 108, in the main storage device 720.

The output of the task plan output unit 112 of the information processing device 100′ is executed by the interface 740 having an output function such as a communication function or a display function and performing output processing under the control of the CPU 710. Communication between the information processing device 100′ and another device is executed by allowing the interface 740 having a communication function to be operated under the control of the CPU 710. The interaction between the information processing device 100′ and the user is executed by the interface 740 having a display device and an input device and operating under the control of the CPU 710.

In a case where the information processing device 200 is implemented in the computer 700, the operations of the automaton generation unit 204, the automaton-based planning unit 206, and the transition system-based planning unit 210 are stored in the auxiliary storage device 730 in the form of a program. The CPU 710 reads the program from the auxiliary storage device 730, develops the program in the main storage device 720, and executes the above processing according to the program.

In addition, the CPU 710 secures a storage area for the information processing device 200 to perform processing in the main storage device 720 according to the program.

The output of the information processing device 200 is executed by the interface 740 having an output function such as a communication function or a display function and performing output processing under the control of the CPU 710. Communication between the information processing device 200 and another device is executed by allowing the interface 740 having a communication function to be operated under the control of the CPU 710. The interaction between the information processing device 200 and the user is executed by the interface 740 having a display device and an input device and operating under the control of the CPU 710.

Any one or more of the above-described programs may be recorded in the nonvolatile recording medium 750. In this case, the interface 740 may read the program from the nonvolatile recording medium 750. The CPU 710 may directly execute the program read by the interface 740, or may temporarily store the program in the main storage device 720 or the auxiliary storage device 730 and execute the program.

A program for executing all or part of the processing performed by the information processing device 100, the information processing device 100′, and the information processing device 200 may be recorded in a computer-readable recording medium, and the processing of each unit may be performed by causing a computer system to read and execute the program recorded in the recording medium. Note that the “computer system” here includes hardware such as an OS and peripheral devices.

The “computer-readable recording medium” refers to a portable medium such as a flexible disk, a magneto-optical disk, a read only memory (ROM), and a compact disc read only memory (CD-ROM), and a storage device such as a hard disk built in a computer system. In addition, the program may be for implementing some of the functions described above, and the functions described above may be implemented in combination with a program already recorded in the computer system.

Although an example embodiment of the present invention has been described in detail with reference to the drawings, a specific configuration is not limited to the example embodiment and includes design update and the like within a range not departing from the gist of the present invention.

Some or all of the above-described example embodiments may be described as the following supplementary notes, but are not limited to the following supplementary notes.

### Supplementary Note 1

An information processing device including:
an automaton generation means for generating an automaton which is a model indicating a state transition in a task to be executed;
an automaton-based planning means for generating an action plan based on the automaton; and
a transition system-based planning means for generating an action plan of a robot for executing the action plan based on the automaton, based on a transition system which is a model indicating a state transition due to an action of a robot.

### Supplementary Note 2

The information processing device according to Supplementary Note 1, in which
the automaton generation means generates an automaton indicated by a graph including a node indicating a state and a directed edge indicating a state transition,
the automaton-based planning means specifies a transition between two nodes in the automaton in generation of an action plan based on the automaton, and
the transition system-based planning means generates an action plan of the robot for making a specified transition.

### Supplementary Note 3

The information processing device according to Supplementary Note 2, in which
the transition system-based planning means divides a task for making the specified transition into tasks achievable by one robot, assigns each of the tasks achievable by one robot to one robot, and generates an action plan for achieving the task by the robot based on the transition system so as to generate an entire action plan for the robot for making a specified transition.

### Supplementary Note 4

The information processing device according to Supplementary Note 2 or 3, in which
the automaton generation means generates, for each edge, an automaton to which a label indicating a task for making a transition indicated by the edge is attached.

### Supplementary Note 5

The information processing device according to Supplementary Note 3 or 4, in which
the transition system is indicated by a graph including a node indicating a state related to an action of one robot and an edge indicating a state transition by an action of the robot, and
the transition system-based planning means reads, from the transition system, an action of a robot for making a state transition by execution of a task achievable by one robot so as to generate an action plan for achieving the task by the robot.

### Supplementary Note 6

The information processing device according to any one of Supplementary Notes 3 to 5, in which
the transition system-based planning means plans, as a flex plan that is a rewritable plan, an action of a robot other than an action for making a transition between nodes of the automaton among actions of each robot in an entire action plan for the robot for making a transition between nodes of the automaton, and generates an entire action plan for a robot for making a transition between nodes of the automaton which is a target of a plan by rewriting the flex plan when it is determined that a transition between nodes of the automaton which is a target of a plan can be made by rewriting the flex plan included in a planned action plan.

### Supplementary Note 7

The information processing device according to any one of Supplementary Notes 2 to 6, in which
the automaton-based planning means generates an action plan based on the automaton by obtaining a path with a minimum cost among paths from a start point to an end point on the automaton.

### Supplementary Note 8

The information processing device according to any one of Supplementary Notes 1 to 7, in which
the task is represented by a logical expression of linear temporal logic.

### Supplementary Note 9

An information processing method for causing a computer to execute:
generating an automaton which is a model indicating a state transition in a task to be executed;
generating an action plan based on the automaton; and
generating an action plan of a robot for executing the action plan based on the automaton, based on a transition system which is a model indicating a state transition due to an action of a robot.

### Supplementary Note 10

A recording medium having stored therein a program for causing a computer to execute:
a process of generating an automaton which is a model indicating a state transition in a task to be executed;
a process of generating an action plan based on the automaton; and
a process of generating an action plan of a robot for executing the action plan based on the automaton, based on a transition system which is a model indicating a state transition due to an action of a robot.

### INDUSTRIAL APPLICABILITY

The present invention may be applied to an information processing device, an information processing method, and a recording medium.

### REFERENCE SIGNS LIST

100, 100′, 200 information processing device
102 task input unit
104, 204 automaton generation unit
106, 206 automaton-based planning unit
108 transition system storage unit
110, 110′, 210 transition system-based planning unit
112 task plan output unit

What is claimed is:

1. An information processing device for an action of a robot, comprising:
an automaton generation circuit configured to generate an automaton which is a model indicating a state transition in a task to be executed;
an automaton-based planning circuit configured to generate an action plan based on the automaton; and
a transition system-based planning circuit configured to generate an action plan of the robot for executing the action plan based on the automaton, based on a transition system which is a model indicating a state transition due to the action of the robot.

2. The information processing device according to claim 1, wherein
the automaton generation circuit generates an automaton indicated by a graph including a node indicating a state and a directed edge indicating a state transition,
the automaton-based planning circuit specifies a transition between two nodes in the automaton in generation of an action plan based on the automaton, and
the transition system-based planning circuit generates the action plan of the robot for making a specified transition.

3. The information processing device according to claim 2, wherein
the transition system-based planning circuit divides a task for making the specified transition into tasks achievable by one robot, assigns each of the tasks achievable by one robot to one robot, and generates an action plan for achieving the task by the one robot based on the transition system so as to generate an entire action plan for the robot for making a specified transition.

4. The information processing device according to claim 2, wherein
the automaton generation circuit generates, for each edge, an automaton to which a label indicating a task for making a transition indicated by the edge is attached.

5. The information processing device according to claim 3, wherein
the transition system is indicated by a graph including a node indicating a state related to an action of the one robot and an edge indicating a state transition by the action of the robot, and
the transition system-based planning circuit reads, from the transition system, the action of the robot for making a state transition by execution of a task achievable by one robot so as to generate an action plan for achieving the task by the robot.

6. The information processing device according to claim 3, wherein
the transition system-based planning circuit plans, as a flex plan that is a rewritable plan, the action of the robot other than an action for making a transition between nodes of the automaton among actions of each robot in an entire action plan for the robot for making a transition between nodes of the automaton, and generates an entire action plan for the robot for making a transition between nodes of the automaton which is a target of a plan by rewriting the flex plan when it is determined that a transition between nodes of the automaton which is a target of a plan can be made by rewriting the flex plan included in a planned action plan.

7. The information processing device according to claim 2, wherein
the automaton-based planning circuit generates an action plan based on the automaton by obtaining a path with a minimum cost among paths from a start point to an end point on the automaton.

8. The information processing device according to claim 1, wherein
the task is represented by a logical expression of linear temporal logic.

9. An information processing method for an action of a robot, for causing a computer to execute:
generating an automaton which is a model indicating a state transition in a task to be executed;
generating an action plan based on the automaton; and
generating an action plan of the robot for executing the action plan based on the automaton, based on a transition system which is a model indicating a state transition due to the action of the robot.

10. A tangible and non-transitory recording medium having stored therein a program for an action of a robot, for causing a computer to execute:
a process of generating an automaton which is a model indicating a state transition in a task to be executed;
a process of generating an action plan based on the automaton; and
a process of generating an action plan of the robot for executing the action plan based on the automaton, based on a transition system which is a model indicating a state transition due to the action of the robot.
